(19) United States
(12) Patent Application Publication
(10) Pub. No.: US 2003/0115606 A1
(43) Pub. Date: Jun. 19, 2003

(54) Method of providing cost effective programs to consumers using electronic program guide information

(76) Inventor: Benoit Pol Menez, Carmel (IN)

Correspondence Address: JOSEPH S. TRIPOLI, PATENT OPERATIONS-GE AND RCA, LICENSING MANGEMENT OPERATION, INC., CN 5312, PRINCETON, NJ, 08543-0028, US

(21) Appl. No.: 10/020,713

(22) Filed: Dec. 14, 2001

(51) Int. Cl. H04N 5/445; H04N 7/16; H04N 7/173

(52) U.S. Cl. 725/60; 725/1; 725/4; 725/110; 725/42; 725/51; 725/104

(57) ABSTRACT

The invention disclosed herein provides a method (200) of providing programs to consumers. The method can include sending electronic program guide information through a digital television network to a digital television receiver (220). The electronic program guide information can include at least one selectable program identifier for initiating a purchase transaction for an item associated with the selectable program identifier. The selectable program identifier can be presented (225), and responsive to a selection of the program identifier, a computer communications link between the digital television receiver and at least one remote server can be established (235). At least one potential purchase transaction for a sale of the item associated with the program identifier can be downloaded (245). The potential purchase transactions can be presented (250), and responsive to a selection (255) of one of the potential purchase transactions, the selected purchase transaction can be initiated (260).

### BACKGROUND OF THE INVENTION

1. Technical Field

The present invention relates to the sale of programs using a digital television network, and more particularly, to providing consumers with an opportunity to purchase programs such as, for example, a movie on a DVD at competitive prices.

2. Description of the Related Art

Television broadcasters offer a wide variety of digital broadcast services. These digital broadcast services can be provided to television subscribers via wireless satellite based communication networks such as DirectTV (TM) or through conventional cable systems. Regardless of the delivery method, these services can include different channels offering diverse content such as movies, sports, travel, and the like. Audio only channels also have become available.

Presently, a subscriber interested in purchasing a copy of a broadcast program must purchase the copy from an e-commerce Web site or a “brick and mortar” storefront. Contact information specifying a Web site or a physical address where the subscriber can order or purchase a compact disk (CD) or a digital video disk (DVD) copy of the broadcast program is often included within a broadcast transmission. Still, the subscriber must go to the physical storefront to purchase a copy of the program or use a computer to access the Web site to order a copy of the program. This added time and effort can deter subscribers from purchasing copies of programs. Moreover, subscribers have no assurance that the asking price of the program is competitive with other vendors, or that the vendor is trustworthy. Thus, a need exists for a cost effective and efficient method of delivering program or other items associated with the programs to consumers.

### SUMMARY OF THE INVENTION

The invention disclosed herein provides a method for providing programs or other items to consumers of digital broadcast services. The present invention allows a consumer to purchase programs via the same physical device through which the program is played. Accordingly, broadcasters can send programs and program information through a digital television network to a subscriber digital receiver (SDR). Programs, as used herein, can include visual content, audio content, and/or audiovisual content, as well as other products which are associated with the programs. Program information can include any information which can be used to uniquely identify a particular program. In any case, through the SDR, subscribers can initiate a purchase transaction for a copy of selected programs or other items which are received by the SDR. Accordingly, consumers can purchase items including, but not limited to, compact disks (CDs), digital video disks (DVDs), audio cassettes, video cassettes, video compact disks (VCDs), and super-video compact disk (SVCD) copies of broadcast programs received by the SDR as part of subscriber programming, as well as other products that may be advertised via the digital television network. Alternatively, consumers can download a copy of a program for storage on a local device, for example a magnetic data store or other optical device.

One aspect of the present invention can include a method of providing programs to consumers. The method can include sending electronic program guide information through a digital television network to a digital television receiver. The electronic program guide information can include at least one selectable program identifier for initiating a purchase transaction for an item associated with the selectable program identifier. The selectable program identifier can be presented, and responsive to a selection of the program identifier, a computer communications link between the digital television receiver and at least one remote server can be established. At least one potential purchase transaction for a sale of the item associated with the program identifier can be downloaded. The potential purchase transactions can be presented, and responsive to a selection of one of the potential purchase transactions, the selected purchase transaction can be initiated.

Another embodiment of the invention can include establishing a computer communications link between a digital television receiver and at least one remote server. Electronic program guide information can be downloaded from the remote server. Electronic program guide information can include at least one selectable program identifier for initiating a purchase transaction for an item associated with the selectable program identifier. The selectable program identifier can be presented, and responsive to a selection of the program identifier, at least one potential purchase transaction for a sale of the item associated with the program identifier can be downloaded from the remote server. The potential purchase transactions can be presented, and responsive to a selection of one of the potential purchase transactions, the selected purchase transaction can be initiated.

### BRIEF DESCRIPTION OF THE DRAWINGS

There are shown in the drawings embodiments which are presently preferred, it being understood, however, that the invention is not so limited to the precise arrangements and instrumentalities shown.

FIG. 1 is a schematic diagram illustrating a system in accordance with one aspect of the present invention.

FIG. 2 is a flow chart illustrating a method of providing programs to consumers through a digital television network in accordance with the present invention.

### DETAILED DESCRIPTION OF THE PREFERRED EMBODIMENTS

The invention disclosed herein provides a method for providing programs or other items to consumers. In particular, the present invention allows a consumer to purchase programs via the same physical device through which the program is played. Broadcasters can send programs including visual content, audio content, or audiovisual content through a digital television network to a subscriber digital receiver (SDR), also referred to as a “set-top-box”. Program information such as electronic program guide (EPG) information which can uniquely identify a particular program also can be provided. Notably, the EPG information can include information associated with previously broadcast programs. In any case, through the SDR, subscribers can initiate a purchase transaction for a copy of selected programs received by the SDR. Accordingly, consumers can purchase copies of broadcast programs received by the SDR as part of subscriber programming. These copies can be in any of a variety of media formats including, but not limited to, compact disk (CD), digital video disk (DVD), audio cassette, video cassette, video compact disk (VCD), super-video compact disk (SVCD), and the like. It should be understood within contemplation of the present invention that other products can be purchased in a similar manner. Still, consumers can download a copy of a program for storage on a local device, for example a magnetic data store or other optical device. Additionally, the program can be downloaded in any of a variety of formats.

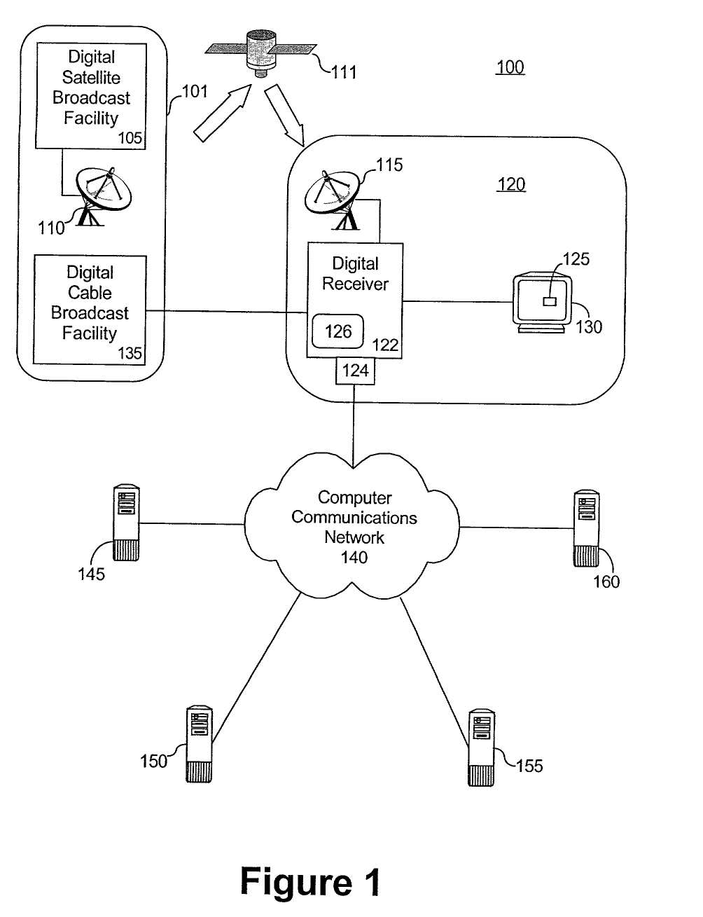

FIG. 1 is a schematic diagram illustrating a system 100 in accordance with one aspect of the present invention. As shown in FIG. 1, the system 100 can include a digital television broadcast network 101, subscriber equipment 120, a computer communications network 140, and one or more servers 145-160. The digital television broadcast network 101 can include a digital satellite broadcast facility 105 which can be operatively connected to a satellite uplink 110 and corresponding satellite 111 for wirelessly transmitting digitally encoded programs and associated program information to subscriber equipment 120. The television broadcast network 101 further can include a digital cable broadcast facility 135 which can broadcast digitally encoded programs and associated program information to subscriber equipment 120 through a conventional cable television network.

As previously mentioned, programs, as used herein, can include visual content, audio content, and/or audiovisual content. More specifically, programs can include, but are not limited to, movies, film or radio documentaries, television programs, music, video games, and other multi-media entertainment which can be digitally encoded and broadcast via a digital television broadcast network. Alternatively, the programs can include advertising for products that may also have unique identifiers associated therein. The EPG information can include title, broadcast time, and channel information relating to programs provided by a digital television broadcast system, and any other information typically provided as part of EPG information which can uniquely identify a program. If the program is associated with a unique identifier, such as a Globally Unique Identifier, the unique identifier also can be included within the EPG program information.

The subscriber equipment 120 can include a satellite receiver 115 which can receive programs and program information transmitted from satellite 111. An SDR 122 can be configured to receive signals from the satellite receiver 115 as well as signals broadcast from the digital cable broadcast facility 135 through a conventional cable network. Notably, the SDR 122 can be configured to decode any received program and program information received from the digital television broadcast network. A memory unit 126 can be included within the SDR. The memory unit 126 can include, for example, volatile and/or non-volatile memories. In one embodiment, the memory unit 126 can include a bulk storage unit. Regardless, selected program information from the television broadcast network 101 can be stored in memory 126 for a predetermined time period.

As shown in FIG. 1, the SDR 122 can be operatively connected to the computer communications network 140. Specifically, the SDR 122 can include a modem 124 such as a cable modem or a modem for connecting to the computer communications network 140 via the public switched telephone network (PSTN) for example. Accordingly, the SDR 122 can be configured to send and receive information via the computer communications network 140, and process received information for presentation on a television or other display 130. For example, a program identifier 125 is displayed on display 130. Information received through the modem 124 also can be stored within memory unit 126. It should be appreciated that other equipment can be included and operatively connected to the SDR 122 such as an audio system for playing audio content. Further, the subscriber equipment 120 can include a control unit, such as a conventional remote control unit or a keyboard through which the consumer can interact with the SDR 122 to make programming and other selections.

The communications network 140 can be the Internet where communication can be facilitated using TCP/IP, HTTP, XML, and FTP protocols, each well known in the art. Alternatively, communication can be facilitated though direct network access, a local area network, a wide area network, an Integrated Service Digital Network (ISDN) connection, or a series of direct dial up connections. Any suitable method and communications protocol for connecting computers or computing devices, including electronic data interchange (EDI), can be used.

One or more servers 145-160 can be included within the system 100. As shown, the servers 145-160 can be communicatively linked with one another and the SDR 122 via the computer communications network 140. Servers 150-160 can correspond to registered vendors. Registered vendors can be vendors who have been determined to be reliable and/or offer advantageous pricing such as volume discounts. Accordingly, servers 150-160 can include program information specifying programs for sale by each respective registered vendor. The servers 150-160 also can include a listing of proposed transaction terms for the sale of copies of the programs listed therein. For example, the proposed transaction terms can include the availability of a particular program or item, the physical media type in which the program is embodied and sold, such as DVD or CD, the price of the program, as well as other necessary information such as shipping and handling charges and relevant sales tax data. Server 145 can preferably correspond to the entity providing the program or item sale service (hereafter the “service provider”). Server 145 further can be programmed with a search engine which can be configured to communicate with each registered vendor database located within each respective registered vendor server. Notably, the service provider can determine which vendors qualify as registered vendors.

In operation, the SDR 122 can receive digital programs and associated program information from the digital broadcast facility 105 and/or from the digital cable broadcast facility 135. The programs and program information can be decoded and displayed upon the display 130. The SDR 122 also can download program information via the computer communications network 140 from a remote server. Regardless of where the program information is obtained, it can be stored for a predetermined time period in memory 126. Accordingly, the program information can include EPG information associated with previously broadcast programs. Responsive to a consumer selection of a program identifier 125 (which can be displayed on display 130), the SDR 122 can connect to server 145 via the computer communications network 140 to obtain one or more proposed, or potential, transactions for the sale of a copy of the program or item associated with the program identifier selected by the consumer. These proposed transactions can be provided to the SDR 122 for presentation to the consumer via display 130. The consumer then can select a suitable transaction based on the terms of the sale and consumer preferences, such as expected delivery date, cost, and the like.

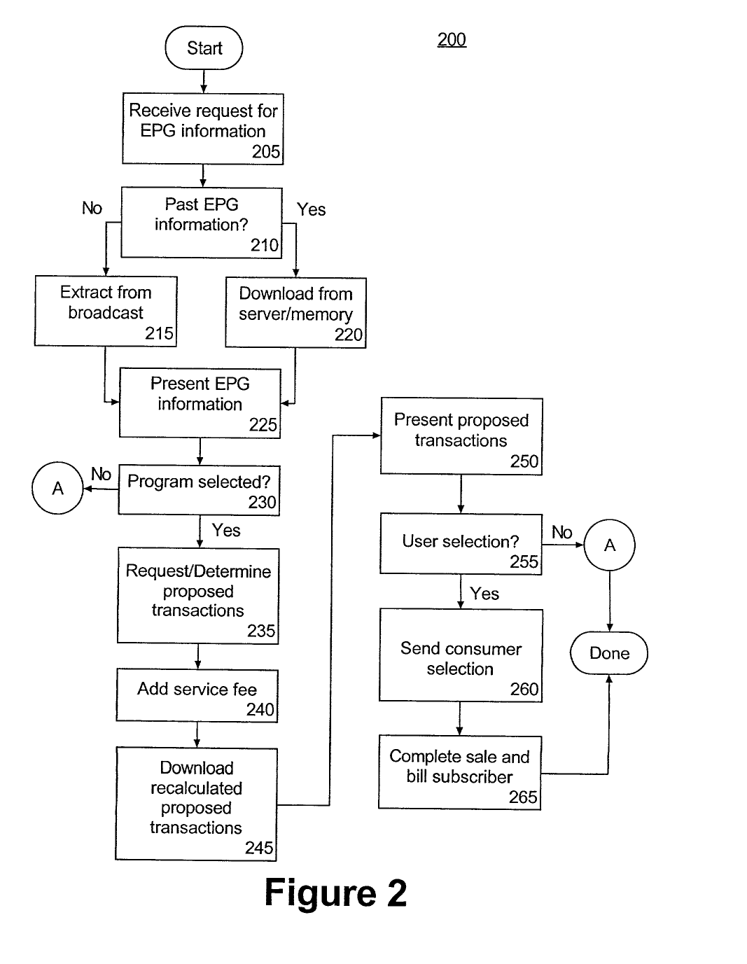

FIG. 2 is a flow chart illustrating an exemplary method 200 of providing programs to subscribers. As shown in FIG. 2, the method can begin in step 205, where a user requests EPG information. In step 210, if the request is for EPG information relating to present or future programming, this information typically is available within the broadcast signal received from the broadcast system. Accordingly, the method can continue to step 215 where the EPG information can be extracted from the broadcast signal. If the request is for past EPG information, however, the method can continue to step 220. In step 220, the past EPG information can be retrieved from the memory of the SDR or from the service provider server. For example, the SDR can be configured to store EPG information for a predetermined amount of time. Accordingly, if the requested EPG information is available in the memory of the SDR, the information can be retrieved. If, however, the EPG information is not available within the SDR memory, the SDR can establish an Internet connection with the service provider server and download the EPG information. It should be appreciated that EPG information, whether received from the broadcast system or the service provider server, can be stored in the SDR memory for later use. In step 225, the requested EPG information can be presented to the user.

In step 230, if the subscriber does not select a program from the EPG information, for example within a predetermined time period, the method can end. Alternatively, the method can continually loop through step 230 until the subscriber cancels the display of EPG information. In step 235, responsive to a selection of one of the programs or items listed in the EPG information, the SDR can request proposed transactions for the sale of the selected program or items from registered vendors. If a link with the service provider server has yet to be established, a link can be established at that time. An identifier included within the EPG information and associated with the selected program can be provided to the service provider server. In one embodiment of the present invention, the service provider server can include a listing of the sale terms (potential transactions) available from registered vendors for the sale of the selected program. The identifier can be compared to this listing, which can be updated periodically. Alternatively, the service provider server can receive the request and identifier from the SDR, and in turn query different vendor servers for proposed transaction terms for the sale of the program corresponding to the identifier. The various vendors can respond to the service provider server with transaction terms for the sale of the specified program.

It should be appreciated that responsive to a selection of a program in the EPG information, an electronic form can be displayed. Using the electronic form, the consumer select or specify information relating to the purchase transaction such as a preferred media format, a delivery address, and payment/billing options. For example, the consumer can provide credit card account information to charge the transaction to a credit card. Alternatively, the consumer can charge the purchase to a previously specified charge card or other account such as the consumer's account with the broadcaster.

In step 240, the service provider server can recalculate each of the proposed transaction terms from the registered vendors to include a service fee. In the case where the service provider includes a listing of transaction terms available from the registered vendors, the service fee can be included within the proposed transaction terms as the terms are updated or responsive to a consumer request for transaction information.

In step 245, the recalculated proposed transactions for the specified program can be downloaded to the SDR via the Internet connection. Accordingly, in step 250, the SDR can process the received information and display the different vendor transaction terms. In step 255, the subscriber can select a proposed transaction or reject the proposed transactions. If the proposed transactions are rejected, the method can end. If one is selected, in step 260 the selection can be provided or uploaded to the service provider server for processing. Notably, in one embodiment of the invention, and if not previously provided, an electronic form can be presented to the consumer wherein information such as the delivery address, media format, billing address, payment information, and the like can be entered. For example, such can be the case where the subscriber had previously selected a single icon. Still, if the consumer has registered with the service, the service can utilize consumer preference information which can be provided at the time of registration. The consumer preference information can include billing information, payment information, delivery information, and preferred media format. The consumer further can be prompted to verify the accuracy of the terms of the sale allowing the consumer an additional chance to cancel the purchase transaction.

In step 265, the transaction can be processed. More specifically, the service provider can charge a specified consumer account and provide the selected registered vendor with the information necessary to ship the program or item to the consumer. The service provider also can provide payment to the vendor. Accordingly, the registered vendor can deliver to the consumer a copy of the requested program in the specified media format. The program copy can be delivered using the appropriate delivery method as specified in the transaction terms. For example, the program can be downloaded in a consumer specified format, the program can be shipped in a consumer specified medium, or a product can be shipped to the consumer. Notably, depending upon the preference of the service provider, the broadcasters, or the consumer, the identity of the registered vendors may or may not be revealed to the consumer.

Those skilled in the art will appreciate that one or more, if not all, of the communications among the various components of FIG. 1 can be encrypted. Moreover, the communications among the components can be authenticated on the sending side, the receiving side, or on both sides of each communication. Encryption and authentication techniques can provide added security as well as help to maintain data integrity.

The invention disclosed herein can be embodied in other specific forms without departing from the spirit or essential attributes thereof. Accordingly, reference should be made to the following claims, rather than to the foregoing specification, as indicating the scope of the invention.

We claim:

1. A method of providing programs to consumers comprising:
a) sending electronic program guide information through a digital television network to a digital television receiver, said electronic program guide information comprising at least one selectable program identifier for initiating a purchase transaction for an item associated with said selectable program identifier;
b) presenting said selectable program identifier;
c) responsive to a selection of said program identifier, establishing a computer communications link between said digital television receiver and at least one remote server;
d) downloading from said remote server at least one potential purchase transaction for a sale of said item associated with said program identifier;
e) presenting said potential purchase transactions; and
f) responsive to a selection of one of said potential purchase transactions, initiating said selected purchase transaction.

2. The method of claim 1, wherein said electronic program guide information is stored in said digital television receiver and includes information associated with programs previously broadcast for a predetermined time period.

3. The method of claim 1, wherein each said potential purchase transaction is associated with a registered vendor.

4. The method of claim 1, wherein said potential purchase transactions are included within said remote server.

5. The method of claim 1, further comprising:
determining said potential purchase transactions by querying, through said computer communications link, a plurality of additional remote servers, wherein selected ones of said plurality of remote servers are associated with different registered vendors.

6. The method of claim 5, further comprising:
recalculating said potential purchase transactions to include a service fee.

7. The method of claim 1, further comprising:
receiving said selected purchase transaction at said remote server through said computer communications link.

8. The method of claim 7, further comprising:
providing said selected purchase transaction to a registered vendor associated with said selected purchase transaction via said computer communications link.

9. The method of claim 8, further comprising:
billing a consumer account for said purchase transaction.

10. The method of claim 1, further comprising:
presenting an electronic order form for said sale of said item associated with said selected program identifier, and uploading said electronic order form to said remote server via said computer communications link.

11. The method of claim 1, wherein said computer communications link is an Internet connection.

12. The method of claim 1, wherein said item associated with said program identifier is a copy of said program in a physical medium.

13. The method of claim 12, wherein said physical medium is selected from the group consisting of compact disks, digital video disks, audio cassettes, and video cassettes.

14. A method of providing programs to consumers comprising:
a) establishing a computer communications link between a digital television receiver and at least one remote server;
b) downloading from said remote server electronic program guide information comprising at least one selectable program identifier for initiating a purchase transaction for an item associated with said selectable program identifier;
c) presenting said selectable program identifier;
d) responsive to a selection of said program identifier, downloading from said remote server at least one potential purchase transaction for a sale of said item associated with said program identifier;
e) presenting said potential purchase transactions; and
f) responsive to a selection of one of said potential purchase transactions, initiating said selected purchase transaction.

15. The method of claim 14, wherein said electronic program guide information is stored in said digital television receiver and includes information associated with programs previously broadcast within a predetermined time period.

16. The method of claim 14, wherein each said potential purchase transaction is associated with a registered vendor.

17. The method of claim 14, wherein said potential purchase transactions are included within said remote server.

18. The method of claim 14, further comprising:
determining said potential purchase transactions by querying, through said computer communications link, a plurality of additional remote servers, wherein selected ones of said plurality of remote servers are associated with different registered vendors.

19. The method of claim 18, further comprising:
recalculating said potential purchase transactions to include a service fee.

20. The method of claim 14, further comprising:
receiving said selected purchase transaction at said remote server through said computer communications link.

21. The method of claim 20, further comprising:
providing said selected purchase transaction to a registered vendor associated with said selected purchase transaction via said computer communications link.

22. The method of claim 21, further comprising:
billing a consumer account for said purchase transaction.

23. The method of claim 14, further comprising:
presenting an electronic order form for said sale of said item associated with said selected program identifier, and uploading said electronic order form to said remote server via said computer communications link.

24. The method of claim 14, wherein said computer communications link is an Internet connection.

25. The method of claim 14, wherein said item associated with said program identifier is a copy of said program in a physical medium.

26. The method of claim 14, wherein said physical medium is selected from the group consisting of compact disks, digital video disks, audio cassettes, and video cassettes.
